(19) United States
(12) Patent Application Publication
(10) Pub. No.: US 2012/0300489 A1
(43) Pub. Date: Nov. 29, 2012

(54) Light Generator

(75) Inventors: Maurice Stanley, Malvern (GB); David Arthur Orchard, Malvern (GB)

(73) Assignee: QINETIQ LIMITED, Farnborough Hampshire (UK)

(21) Appl. No.: 13/576,782

(22) PCT Filed: Feb. 3, 2011
(86) PCT No.: PCT/GB11/00148

§ 371 Date: Aug. 2, 2012

(30) Foreign Application Priority Data
Feb. 9, 2010 (GB) 1002085.7

(51) Int. Cl. G09F 13/14; F21V 5/02

(52) U.S. Cl. 362/559

(57) ABSTRACT

A structured light generator for illuminating a scene comprising a light source and a light guide comprising a tube having a longitudinal axis and having substantially reflective sides arranged to project an array of distinct images of the light source towards the scene in the manner of a kaleidoscope, wherein including a light deflection element to redirect light so that the projection axis and the light guide axis are angled with respect to one another. In this way the light guide, which is typically an elongate structure, can be ‘folded’ away from the direction of light projection, which offers advantages in terms of packaging of the light generator where thickness in the direction of projection is desirably minimised.

This invention relates to a structured light generator for illuminating a scene such as might be used with a range finding apparatus such as an imaging range finding system.

Imaging range finding systems often illuminate a scene and image the light reflected from the scene to determine range information.

One known system, a so called triangulation system, uses a source arranged to illuminate a scene with a beam of light such that a spot appears in the scene. A detector is oriented in a predetermined fashion with respect to the source such that the position of the spot of light in the scene reveals range information. The beam of light may be scanned in both azimuth and elevation across the scene to generate range information from across the whole scene. In some systems the beam of light may be a linear beam such that one dimensional range information is gathered simultaneously and the linear beam scanned in a perpendicular direction to gain range information in the other dimension.

Illumination systems of this sort often use laser systems. Laser systems may have safety implications and require complicated and relatively expensive scanning mechanisms. Lasers can remain small and operate at low power, but issues such as speckle remain a potential problem.

Another type of illumination system is described in U.S. Pat. No. 6,377,353. Here a structured light generator is described which comprises a light source arranged in front of a patterned slide which has an array of apertures therein. Light from the sources only passes through the apertures and projects an array of spots onto the scene. The range information in this apparatus is determined by analysing the size and shape of the spots formed.

This type of illumination system blocks a proportion of the light generated by the source however and as such requires a relatively high power source to generate the illumination required. Further the depth of field of the illuminations system is somewhat limited and discrimination is difficult at low ranges.

WO 2004/044523 describes a structured light generator which instead uses a light source arranged to illuminate part of the input face of a tube having substantially reflective sides, arranged together with projection optics so as to project an array of images of the light source towards the scene. The light guide in effect operates as a kaleidoscope. Light from the source is reflected from the sides of the tube and can undergo a number of reflection paths within the tube. The result is that multiple images of the light source are produced and projected onto the scene. One described embodiment is a square section tube having a side length of 2-3 mm. The light guide may have a length of a few tens of millimetres, a light guide may be between 10 and 70 mm long

It will be understood that structured light refers to patterns having a plurality of recognisable features in a known geometry. Common structured light patterns include regular arrays of spots, parallel lines or grids of lines.

It is an object of the present invention to provide an improved structured light generator

According to a first aspect of the invention there is provided a structured light generator for illuminating a scene comprising a light source arranged to illuminate part of the input face of a light guide, the light guide comprising a tube having a longitudinal axis and having substantially reflective sides and being arranged together with projection optics so as to project an array of distinct images of the light source towards the scene, wherein said light generator includes a light deflection element adapted to redirect light such that the direction of projection of said array of images is at an angle to the longitudinal axis.

In this way the light guide, which is typically an elongate structure, can be ‘folded’ away from the direction of light projection, which offers advantages in terms of packaging of the light generator where thickness in the direction of projection is desirably minimised. This is often the case in the example of mobile telephones. Mechanical advantage may also be provided if the arrangement can be mounted along or under the surface of a substrate, with the direction of projection being out of the plane of the substrate. It may be possible to integrate an appropriate light guide into the surface of a chip for example.

The light deflection is, in certain embodiments, preferably adapted to alter the direction of the light output pattern, but to leave the pattern itself substantially unaffected. In one embodiment therefore, the light deflection element is a planar reflector arranged between said light guide and said projection optics. In this case the optical axis of the light guide and the optical axis of the projection optics are preferably angled with respect to one another.

In order to achieve minimum thickness in the direction of projection, the light guide is desirably ‘folded’ through 90 degrees to lie perpendicular to the projection direction.

A prism is used as the light deflection element in embodiments, however a standard mirror might also be employed. In certain embodiments, a mirror or prism can be integrated with the light guide as will be explained in greater detail below.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying drawings, in which:

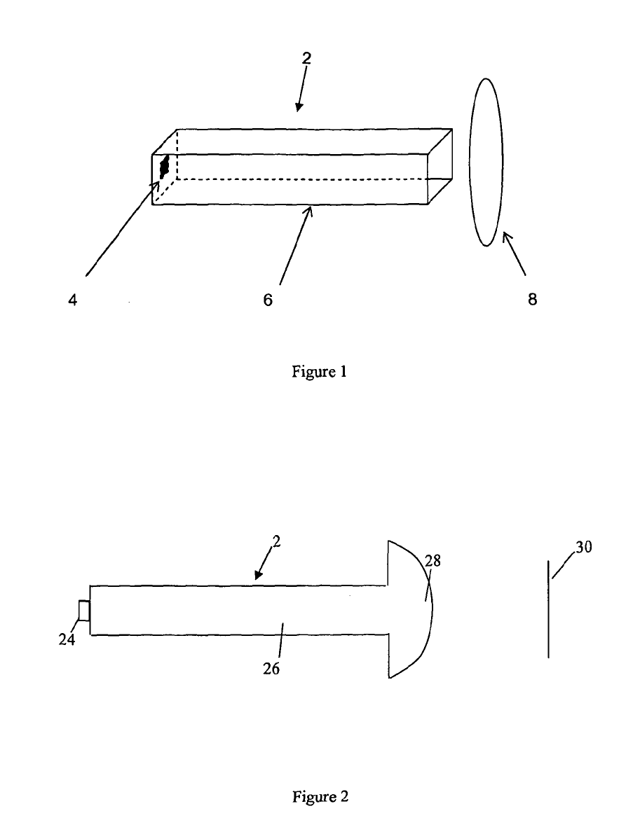

FIGS. 1 and 2 illustrate a prior art structured light source

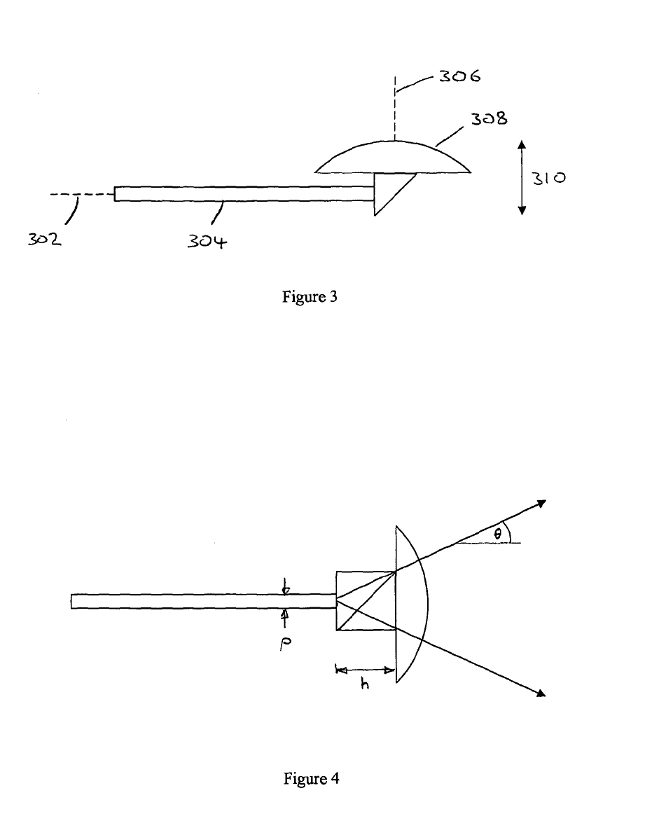

FIG. 3 shows a structured light generator according to the present invention

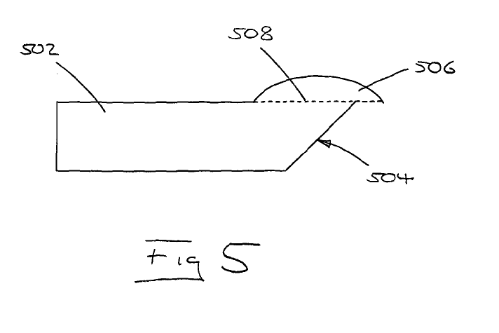

FIG. 4 illustrates certain parameters of an embodiment of the invention.

FIG. 5 illustrates a light projector having integrated components.

A structured light source generally indicated 2 is shown in FIG. 1. A light source 4 is located adjacent an input face of a kaleidoscope 6. At the other end is located a simple projection lens 8. The projection lens is shown spaced from the kaleidoscope for the purposes of clarity but would generally be located adjacent the output face of the kaleidoscope.

The light source 4 is in this example an infrared light emitting diode (LED). Infrared is useful for ranging applications as the array of projected spots need not interfere with a visual image being acquired and infrared LEDs and detectors are reasonably inexpensive. However the skilled person would appreciate that other wavelengths and other light sources could be used for other applications without departing from the spirit of the invention.

The kaleidoscope is a hollow tube with internally reflective walls. The kaleidoscope could be made from any material with suitable rigidity and the internal walls coated with suitable dielectric coatings. However the skilled person would appreciate that the kaleidoscope could comprise a solid bar. Any material which is transparent at the wavelength of operation of the LED would suffice, such as clear optical glass. The material would need to be arranged such that at the interface between the kaleidoscope and the surrounding air the light is totally internally reflected within the kaleidoscope. Reflection could also be achieved using additional (silvering) coatings, particularly in regions that may be cemented with potentially index matching cements/epoxies etc. Where high projection angles are required this could require the full length of the kaleidoscope to be clad in a reflective material. An ideal kaleidoscope would have perfectly rectilinear walls with 100% reflectivity. The effect of the kaleidoscope tube is such that multiple images of the LED can be seen at the output end of the kaleidoscope.

Projection lens 8 is a simple singlet lens arranged at the end of kaleidoscope and is chosen so as to project the array of images of the LED 4 onto the scene. The projection geometry again can be chosen according to the application and the depth of field required but a simple geometry is to place the array of spots at or close to the focal plane of the lens. A useful feature of the projector arrangement according to embodiments of the present invention is that all the beams pass through the end of the kaleidoscope and can be thought of as originating from the centre of the output face of the kaleidoscope. Projection lens 8 may therefore be a hemispherical lens and, if arranged with its axis coincident with the centre of the exit face, will preserve the apparent origin of the beams. FIG. 2 shows a hemispherical lens 28 formed integrally with the kaleidoscope 26. Thus the projector according to the present invention is advantageous in projecting images of the input face of the kaleidoscope across a wide angle.

FIG. 3 illustrates an embodiment of a structured light generator according to the present invention.

The optical axis 302 of the elongate light guide or pipe 304 can be seen to be arranged substantially perpendicular to the optical axis 306 (and the direction of projection) of the projection lens 308. It can be seen that the overall depth or thickness 310 of the device is significantly reduced. A right angle prism is disposed between the light guide and projection lens to redirect light emerging from the light guide through 90 degrees, to be aligned with the projection lens. In some embodiments the prism can be considered as part of the overall hemispherical lens thickness, and so has the added benefit of helping reduce the bulk and weight of that collimation lens. A prism or reflector could be arranged to redirect light after it has passed through the projection lens, but this is unlikely to be attractive for presently envisaged applications.

It may be advantageous in other embodiments to redirect light by angles other than 90 degrees, to suit the particular application. The prism, or deflecting element might also be arranged to redirect light so that it does not enter the projection lens along the axis of that lens.

FIG. 4 illustrates schematically the ‘unfolding’ of the arrangement of FIG. 3.

Considering FIG. 4 it can be seen that, when the kaleidoscope is folded with a prism behind the lens, the max emission angle (projector field of view) is affected by the aperture of the prism. For a cubic prism of linear dimension h and light guide with width p, the field of view θ(½ angle) is:

Tan θ=(h−p)/2h

In this embodiment therefore θ is maximum at +/−26.5° for a very small pipe (ie when p→0). Offsetting the pipe position away from the centre of the prism can also be used to bias the field of view up to a theoretical limit of −0 to +45°.

As noted in relation to FIG. 3, the prism, or deflection element may be integrated with the projection optics. FIG. 5 illustrates an embodiment in which the prism is integrated with the light guide. The output face 504 of light guide 502 is cut at a desired angle, and may be polished or silvered to promote reflection. This could be achieved with a single moulded component for example. This reduces the number of optical interfaces, and ensures accurate alignment. Projection lens 506 may also be incorporated into a single structure in some embodiments, as indicated by dashed line 508.

As an alternative to a dedicated projection lens, it may be possible in embodiments to arrange for the prism or reflector not only to redirect the light, but to provide the appropriate shaping function for projection also. In such an embodiment a tilted spherical mirror could be employed for example.

It will be understood that the present invention has been described above purely by way of example, and modification of detail can be made within the scope of the invention.

Each feature disclosed in the description, and (where appropriate) the claims and drawings may be provided independently or in any appropriate combination.

1. A structured light generator for illuminating a scene comprising a light source arranged to illuminate part of the input face of a light guide, the light guide comprising a tube having a longitudinal axis and having substantially reflective sides and being arranged together with projection optics so as to project an array of distinct images of the light source towards the scene, wherein said light generator includes a light deflection element adapted to redirect light such that the direction of projection of said array of images is at an angle to the longitudinal axis

2. A structured light generator according to claim 1, wherein said light deflection element is a planar reflector arranged between said light guide and said projection optics.

3. A structured light generator according to claim 1, wherein the optical axis of said light guide and the optical axis of said projection optics are angled with respect to one another.

4. A structured light generator according to claim 1, wherein the direction of projection of said array of images is substantially perpendicular to said light guide axis

5. A structured light generator according to claim 1, wherein said light deflection element comprises a prism.

6. A structured light generator according to claim 1, wherein the light guide comprises a tube having a constant cross section.

7. A structured light generator according to claim 6, wherein the cross section of the tube is a regular polygon.

8. A structured light generator according to claim 1, wherein the light deflection element is integrated with the projection optics.

9. A structured light generator according to claim 1, wherein the light deflection element is integrated with the light guide.
